(19) United States
(12) Patent Application Publication
(10) Pub. No.: US 2025/0051060 A1
(43) Pub. Date: Feb. 13, 2025

(54) PACKAGE CLOSURES AND METHODS AND DEVICES FOR PRODUCING PACKAGE CLOSURES

(71) Applicant: Petro-Pack AB, Ljungby (SE)

(72) Inventor: Hugo NILSSON, Ljungby (SE)

(73) Assignee: Petro-Pack AB, Ljungby (SE)

(21) Appl. No.: 18/723,285

(22) PCT Filed: Jan. 9, 2023
(86) PCT No.: PCT/SE2023/050017

§ 371 Date: Jun. 21, 2024

(30) Foreign Application Priority Data
Jan. 10, 2022 (SE) 2250010-2

(51) Int. Cl. B65D 41/32; B29C 53/04; B29C 53/82; B29D 99/00; B29L 31/56

(52) U.S. Cl. CPC B65D 41/32; B29C 53/04; B29C 53/82; B29D 99/0096; B29L 2031/565; B65D 2251/1008; B65D 2251/105; B65D 2401/15

(57) ABSTRACT

A method of producing a package closure (10) of plastic material by means of a mould comprising movable jaws (35, 36), a counterpart (37), an outer first tool core part (38), an inner second tool core part (39) and an ejector (40), wherein the outer first tool core part, the second tool core part and the ejector are axially displaceable relative each other, comprising the steps of axially displacing the outer first tool core part and the second tool core part in relation to each other in a first direction, thereby disengaging the cap from the outer first tool core part while keeping the inner second tool core part engaged with the cap, and then axially displacing the inner second tool core part and the outer first tool core part and/or the ejector (32) in relation to each other in the first direction or in an opposite second direction while folding a foldable portion (21) of the package closure inward through an inherent flexibility of the package closure (10), Disclosed is also a device for producing the package closure (10) and various embodiments of package closures.

### FIELD OF THE INVENTION

The present invention relates to package closures and methods and devices for producing them. Package closures of this type comprises a cap having a top portion for closing the opening of a neck. Package closures of this type are arranged in plastic materials and have inherent flexible properties, such as thermoplastic materials or other plastic materials having similar properties.

Package closures of this type are generally used for packages for liquid foodstuff, such as milk, juice, water, yoghurt and similar but can be used also for other types of packages. One type of such package closures are often connected to the neck of a bottle, such as a plastic bottle, or similar packaging for closing thereof. Another type of such package closures also comprises the neck (also called spout) and are generally used for packages of carton or a combination of carton and plastic materials or other materials, such as flat top carton packages or gable top carton packages, which, for example, can be folded from a blank, wherein the package closure is fastened to the package.

### PRIOR ART

A plurality of different types of package closures and caps is disclosed in the prior art. One type of such prior art package closure is disclosed in WO2021/0080497. This document discloses a package closure having a cap for closing the neck, wherein the cap comprises a wall and a folded portion.

However, there is a need to improve such package closures and provide reliable and user-friendly package closures of plastic materials, which are easy to produce, facilitates recycling and which can replace many other package closures used today with reduced material consumption.

### BRIEF DESCRIPTION OF THE INVENTION

One object of the present invention is to provide an efficient method and device for producing a package closure. It is another object of the present invention to provide a cost-efficient package closure, which is easy to produce and use. It is another object of the present invention to provide a package closure which facilitates recycling thereof.

The present invention relates to a method for producing a package closure of plastic material by means of a mould comprising movable jaws, a counterpart, an outer first tool core part, an inner second tool core part and an ejector, wherein the package closure has an axis, and wherein the outer first tool core part, the second tool core part and the ejector are axially displaceable relative each other, comprising the steps of
a) by means of the movable jaws and the counterpart forming an exterior of a cap of the package closure, and by means of the outer first tool core part and the inner second tool core part forming an interior of the cap, wherein an interior of an axially extending wall of the cap, at least an interior of a foldable portion of the cap and an exterior of a sealing ring of the cap is formed by the outer first tool core part, wherein the interior of a top portion of the cap and an interior of the sealing ring is formed by the inner second tool core part, and wherein a hinge is formed in the cap by the movable jaws and the outer tool core part for opening of the cap,
b) removing the jaws from the formed package closure,
c) axially displacing the outer first tool core part and the second tool core part in relation to each other in a first direction, thereby disengaging the cap from the outer first tool core part while keeping the inner second tool core part engaged with the cap,
d) axially displacing the inner second tool core part, the outer first tool core part and/or the ejector in relation to each other further I the first direction or in an opposite second direction while folding the foldable portion inward to its folded position through an inherent flexibility of the package closure,
e) displacing the package closure in relation to the second tool core part by the ejector to disengage the package closure from the second tool core part.

The method according to the invention is a flexible, efficient and adaptable method for producing various types of package closures having a flip lid with or without a neck. Hence, the method makes it possible to produce a cap on its own or together with a neck, wherein the cap may have the same features for opening, sealing and closing both when produced with a neck and without a neck.

The hinge and the breakable notch or bridges can be formed in the wall or between the top portion and the wall. For example, the hinge and the breakable notch or bridges can be arranged in the wall, so that the wall is divided into a lower portion between the foldable portion and the hinge and an upper portion between the hinge and the top portion of the cap. Hence, the lower portion is connected to the neck through the folded portion and the upper portion is connected to the lower portion through the hinge, so that the upper portion carrying the sealing ring and top portion of the cap is movable around the hinge for opening of the cap. Hence, production of a user-friendly package closure is provided.

The method can comprise to form the cap and a neck as a single integrated piece, wherein the foldable portion is connected to the neck through one or more breakable bridges, and to continue to displace the inner second tool core part and the outer first tool core part and/or the ejector in relation to each other to break the breakable bridges and separate the neck and the cap into two pieces, wherein a tubular portion of the neck is enclosed by the wall of the cap. Hence, an efficient method of producing the cap and neck, wherein the cap having a user-friendly flip-lid is mounted on the neck by axial displacement in an efficient manner and without any rotation being necessary.

The method can comprise the step of forming a locking protrusion on the exterior of the neck by means of the jaws, wherein the folded portion is brought to cooperate with the locking protrusion due to the axial displacement for fastening of the cap to the neck in an efficient and reliable manner.

A flexible locking tab can be formed in a portion of the wall by means of one or more of the jaws and the outer first tool core part having a radially inward extending protrusion for releasable locking cooperation with a flange or recess of the neck. Hence, a cap that can be closed again after opening can be produced in an efficient manner.

The cap can be formed with a portion extending radially inward from the wall and also a portion extending axially from the radially extending portion to the top portion of the cap, so that the wall is arranged radially outside of the neck while the axially extending portion is arranged closer to the centre axis of the cap than the neck. For example, the axially extending portion has a diameter smaller than the diameter of the wall and also smaller than the diameter of the neck. Hence, when the cap is opened, the top portion, the axially extending portion, the radially extending portion and the upper portion of the wall is pivoted around the hinge.

The method can comprise the step of displacing an outer first ejector and an inner second ejector axially in relation to each other. Hence, efficient production of the package closure is provided.

One or more flexible holding tabs can be formed adjacent the hinge, e.g. by one or more of the jaws and the outer first tool core part, so that the holding tabs, in the open position of the cap, extend radially inward for cooperation with a rib of the neck to hold the cap in the open position. Hence, a user-friendly package closure is produced in an efficient manner.

The present invention is also related to a device for producing a package closure of plastic material having a flip-lid and a foldable portion for fastening to a neck, wherein the device comprises the jaws, the counterpart, the inner and outer tool core parts and the ejector, wherein the inner and outer tool core parts and the ejector are axially displaceable in relation to each other. The device can comprise an outer first ejector and an inner second ejector being axially displaceable in relation to each other. The jaws can comprise a radially extending recess for forming a locking protrusion on the exterior of the neck, wherein the foldable portion is brought to pass and engage the locking protrusion for fastening of the cap to the neck. The outer first tool core part can comprise a radially inward extending recess for forming, in a portion of the wall, a flexible locking tab having a radially inward extending protrusion for releasable locking cooperation with a flange or recess of the neck. The jaws and the outer first tool core part can be arranged to form one or more flexible holding tabs adjacent the hinge, so that the holding tabs, in the open position of the cap, extend radially inward for cooperation with a rib of the neck to hold the cap in the open position.

The present invention is also related to a package closure comprising a cap for closing an opening of a neck, wherein the cap has a centre axis and is formed with a radially extending top portion, an axially extending sealing ring and an axially extending wall enclosing the sealing ring, characterised in that one end of the wall is formed with a folded portion extending radially inward and upward to a free end thereof, and the wall is formed with a hinge, wherein the cap is openable by folding along the hinge. The folded portion can be used for fastening the cap the neck through cooperation with a locking protrusion of the neck, wherein the hinge in the wall provides for a reliable and user-friendly package closure, which can be produced in an efficient manner with or without the neck.

The hinge can be arranged in the wall, so that a lower portion of the wall is fastened to the neck through the folded portion, wherein an upper portion of the wall can be pivoted around the hinge together with the top portion of the cap. The cap can comprise an axially extending portion and a radially extending portion connecting the upper portion of the wall and the top portion of the cap, wherein the radially extending portion extends radially inward from the upper portion of the wall. Hence, the axially extending portion is arranged closer to the centre axis of the cap than the wall and can, e.g. be aligned with the sealing ring. When the cap is opened, the upper part of the wall, the radially extending portion, the axially extending portion, the top portion and the sealing ring are turned around the hinge. Hence, a reliable, tight and user-friendly package closure is provided, which also facilitates further features, such as a flexible locking tab for releasable locking of the cap in the closed position and/or holding tabs for releasable holding of the cap in the open position.

The structure of the package closure according to the present invention, results in that the package closure can be attached to a package in a manner that it will not come off unintentionally or without breaking it to facilitate recycling. Hence, the cap can be irreversibly attached to the neck by means of the folded portion being pushed over the locking protrusion. Also, the cap can be arranged to stay as one integral piece also after use. For example, the hinge of the cap, and also a hinge to the pull-ring if applicable, can be formed, so that they are not broken by normal use to avoid unintentional removal of the pull-ring and/or the upper portion of the cap. For example, the cap be fixed to the neck and remain attached to the neck throughout its lifetime to facilitate recycling. In addition, the cap can be formed to stay in a single piece throughout its lifetime, i.e. the cap can be formed without any removable parts, to facilitate recycling thereof in its entirety.

Further characteristics and advantages of the present invention will become apparent from the description of the embodiments below, the appended drawings and the dependent claims.

### SHORT DESCRIPTION OF THE DRAWINGS

The invention will now be described more in detail with the aid of embodiment examples and with reference to the accompanying drawings, in which

FIG. 1 is a schematic perspective view from above of a package closure ac-cording to a first embodiment, illustrating a the package closure with a cap, a neck and a pull-ring,

FIG. 2 is a schematic side view of the package closure of FIG. 1,

FIG. 3a is a schematic section view of the package closure according to FIG. 1, illustrating a cap and a neck of the package closure,

FIG. 3b is a section view of a part of the package closure of FIG. 3a, illustrating a hinge for opening of the cap,

FIG. 3c is a section view of a part of the package closure of FIG. 3a, illustrating a locking tab for locking the cap in the closed position,

FIG. 4 is a schematic section view of the package closure according to a second embodiment, wherein the cap has a gripping extension,

FIG. 5 is a schematic perspective view from above of the package closure according to the second embodiment, illustrating holding tabs of the cap,

FIG. 6 is a schematic perspective view of the package closure of FIG. 5, illustrating the locking tab of the cap,

FIG. 7 is a schematic section view of the package closure according to the second embodiment after moulding but before folding thereof, illustrating the cap and the neck as a single integrated piece, wherein the cap is connected to the neck through breakable bridges,

FIG. 8 is a schematic section view of a part of a device for producing the package closure of FIG. 7, illustrating the device with the package closure after moulding and before folding of a foldable portion of the package closure,

FIG. 9 is a schematic section view of the device of FIG. 8, illustrating jaws and a counterpart of the device removed from the package closure and relative axial displacement between inner and outer tool core parts and inner and outer ejectors,

FIG. 10 is a schematic section view of the device of FIGS. 8 and 9, illustrating further axial displacement between inner and outer tool core parts and inner and outer ejectors,

FIG. 11 is a schematic section view of the device of FIGS. 8-10, illustrating folding of the foldable portion of the package closure,

FIG. 12 is a schematic section view of the device of FIGS. 8-11, illustrating the finished package closure with the cap mounted on the neck and in the process of being disengaged from the inner tool core part,

FIG. 13 is a schematic perspective view of a package closure according to a third embodiment, illustrating the package closure with a pull-ring,

FIG. 14 is a schematic section view of the package closure of FIG. 13,

FIG. 15 is a schematic perspective view of the package closure according to a fourth embodiment, illustrating the package closure with a gripping extension and a locking tab of the cap,

FIG. 16 is a schematic section view of the package closure of FIG. 15,

FIG. 17 is a schematic section view of the package closure of FIG. 16 arranged on a bottle neck,

FIG. 18 is a schematic section view of a part of a device for producing the package closure of FIG. 14, illustrating counterpart, jaws and inner and outer tool core parts of the device in a position for moulding the package closure,

FIG. 19 is a schematic section view in section of the device of FIG. 18, wherein the package closure has been disengaged from the jaws and the counterpart,

FIG. 20 is a schematic section view of the device of FIGS. 18 and 19, illustrating relative axial displacement between the inner and outer tool core parts,

FIGS. 21 and 22 are schematic section views of the device of FIGS. 18-20, illustrating folding of the foldable portion of the package closure and release of the package closure from the inner tool core part,

FIG. 23 is a section view of the neck according to one embodiment of the present invention, illustrating a tubular portion and an attachment portion with a welding protrusion to facilitate welding to a package according to one embodiment, and

FIG. 24 is a schematic section view of a portion of the attachment portion of FIG. 23, illustrating the welding protrusion more in detail.

### THE INVENTION

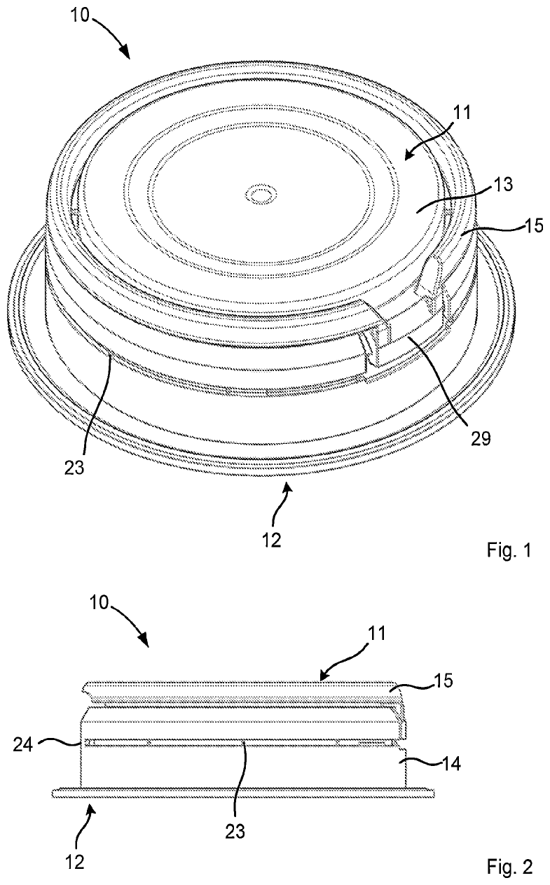

With reference to FIGS. 1-3 a package closure 10 is illustrated according to a first embodiment of the present invention. The package closure 10 is arranged to be fitted to a package, such as a package for liquid foodstuff, such as milk, juice, water, yoghurt and similar or other materials. For example, the package closure 10 is arranged to be attached to a package of plastic material, a combination of carton and plastic material, carton or similar, such as flat top carton packages or gable top carton packages (which generally contain a combination of carton and plastic materials to be liquid-proof). The package is arranged in plastic material and have inherent resilient flexible properties. For example, the package closure 10 is made of thermoplastic materials or other plastic materials having similar properties. The package closure 10 is moulded in a single integrated piece of plastic material, such as thermoplastic material. According to various embodiments, the package closure is moulded in a single integrated piece and is then separated into two pieces, which will be described in more detail below. For example, the package closure 10 is moulded in a single integrated piece by injection moulding. According to one example, the package closure 10 has a weight of 1.2-2 g, such as 1.4-1.8, 1.4-1.6 or 1.4-1.5 g. The height of the package closure 10 is, e.g. 6-10 mm, such as 7-9 mm or 8 mm.

The package closure 10 of the first embodiment comprises a longitudinal centre axis A, a cap 11 and a neck 12 (also called spout) forming an opening for pouring out the content of the package, wherein the cap 11 is arranged for closing the opening of the neck 12 when the package closure 10 is in a closed position as illustrated in FIGS. 1-3. The cap 11 is formed with a radially extending top portion 13 for covering the opening of the neck 12 when the package closure 10 is in the closed position. The cap 11 further comprises an axially extending wall 14 connected to the top portion 13. The cap 11 is formed with a pull-ring 15 for opening of the package closure 10. For example, the package closure 10 is formed so that the wall 14 forms a diameter of 25-40 mm, such as 30-35 mm or 32 mm.

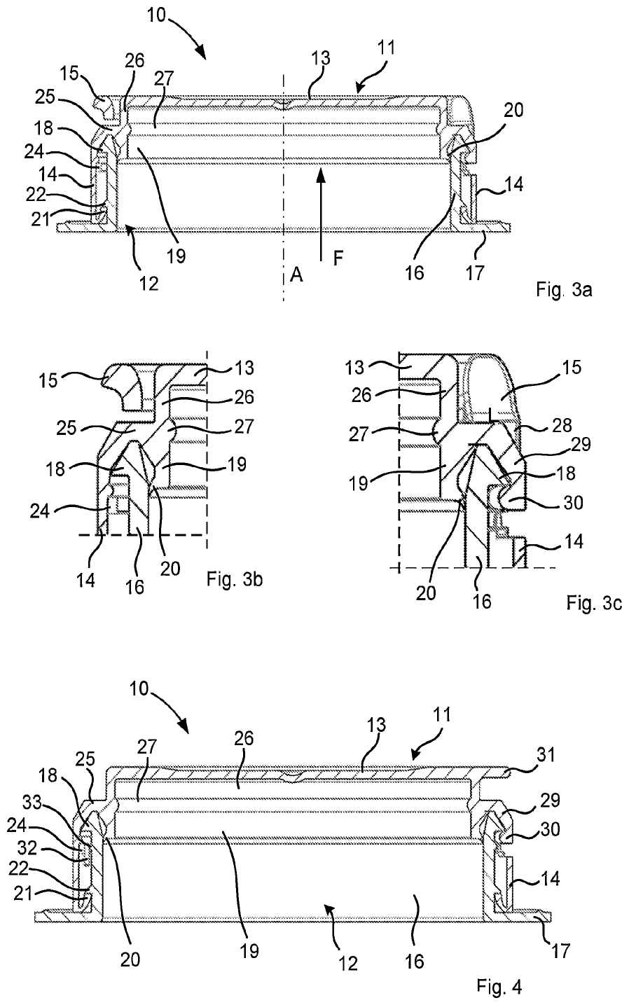

With reference particularly to FIGS. 3a-3c the neck 12 is formed with an axially extending tubular portion 16. A centre axis of the neck 12 is the same as the centre axis A of the package closure 10. In the illustrated embodiment, the package closure 10 is formed substantially as a circular cylinder, wherein the tubular portion 16 of the neck 12 and the wall 14 of the cap 11 are formed with a circular cross-section. Alternatively, the package closure 10 is formed with an oval, substantially rectangular, triangular or other suitably shaped cross-section, e.g. with rounded corners. The neck 12 is formed with an attachment portion 17 for attachments to the package, such as by melting or welding a part of the attachment portion 17 to the package. The attachment portion 17 extends radially outward from the tubular portion 16, such as perpendicular from the tubular portion 16 or at a slanted angle outward and downward from the tubular portion 16. For example, the attachment portion 17 connects to one end of the tubular portion 16, i.e. the lower end which is opposite the top portion 13 of the cap 11.

The neck 12 is formed with an outward projecting flange 18. For example, the flange 18 is arranged at one end of the tubular portion 16, such as the upper end and e.g. in the opposite end as the attachment portion 17. In the illustrated embodiment, the flange 18 extends radially outward from the tubular portion 16 and optionally the tubular portion 16 has a tapering upper end. The flange 18 is, e.g., arranged continuously around the entire circumference of the tubular portion 16 and is formed with a free end.

The cap 11 is formed with an axially extending sealing ring 19 with a sealing flange 20 to interact with the interior side of the tubular portion 16 to form a seal between them. The sealing ring 19 projects from the interior side of the top portion 13 and forms a continuous and closed loop. For example, the sealing ring 19 is resiliently flexible due to the inherent flexible properties of the material of the package closure 10. For example, the sealing ring 19 is cylinder-shaped. The sealing flange 20 is formed with a free end. The outer surface of the sealing ring 19 is formed with the sealing flange 20 extending radially outward for engaging and interacting with the tubular portion 16.

The wall 14 of the cap 11 is formed with a folded portion 21. The folded portion 21 is arranged at an end of the wall 14 opposite the top portion 13 and has a free end. Hence, the folded portion 21 has a first end connected to the wall 14, such as the lower end of the wall 14, wherein an opposite second end of the folded portion 21 is the free end. For example, the folded portion 21 is formed thinner than the wall 14 or with a notch to the wall 14 for folding. The folded portion 21 is folded inward and upward. In the first embodiment, the folded portion 21 is arranged between the tubular portion 16 and the wall 14. Hence, the wall 14 is arranged radially outside of the tubular portion 16. In the illustrated embodiment, the wall 14 is arranged radially outside of the folded portion 21, wherein the wall 14 encloses the folded portion 21 so that the folded portion 21 is arranged between the wall 14 and the tubular portion 16. For example, the folded portion 21 is arranged in a gap between the wall 14 and the tubular portion 16. For example, the wall 14 and the tubular portion 16 are arranged coaxially. In the illustrated embodiment, the wall 14 encloses the tubular portion 16. Hence, the wall 14 is arranged with larger diameter than the tubular portion 16. The folded portion 21 is arranged to cooperate with a radially outward extending locking protrusion 22 of the neck 12 for fastening of the cap 11 to the neck 12. In the illustrated embodiment, the tubular portion 16 of the neck 12 is formed with the locking protrusion 22. The folded portion 21 is arranged to pass the locking protrusion 22 by the inherent resilient flexible properties of the folded portion 21 and then spring back radially to lock the cap 11 to the neck 12 in the axial direction and prevent removal of the cap 11 from the neck 12. For example, the locking protrusion 22 is formed with an outwardly and downwardly slanted upper surface to facilitate for the folded portion 21 to pass.

The cap 11 is openable through a breakable notch or breakable bridges 23 and a hinge 24 arranged in the wall 14, wherein the cap 11 is openable by tearing along the notch or tearing the breakable bridges 23 and folding along the hinge 24. The breakable bridges can be seen in FIG. 2. For example, the breakable bridges 23 are distributed around a major part of the circumference of the wall 14, wherein the hinge 24 extends around a small portion of said circumference. The hinge 24 can also be seen in FIGS. 3a and 3b. The hinge 24 is arranged in the wall 14, wherein an upper part of the cap 11 including the top portion 13 is movable around the hinge 24 for opening of the package closure 10. For example, the wall 14 comprises an upper portion and a lower portion connected through the hinge 24, wherein the lower portion connects to the folded portion 21 and the upper portion connects to the top portion 13, so that the upper portion of the wall 14 is turned around the hinge 24 together with the top portion 13 when the cap 11 is opened. For example, the upper and lower portions of the wall 14 are connected also through the breakable notch or bridges 23 before the first opening of the cap 11.

The upper portion of the wall 14 is connected to the top portion 13 through a radially extending portion 25 and an axially extending portion 26. The radially extending portion 25 extends inward from the wall 14. The axially extending portion 26 is arranged opposite the sealing ring 19 and extends in the opposite direction to the top portion 13 to connect the top portion 13 with the sealing ring 19. The radially inward extending portion 25 connects to the interface between the axially extending portion 26 and the sealing ring 19, forming a leverage line of the cap 11 to increase a radially outward force when the top portion 13 is subject to an axial force F due to increased pressure inside a package on which the package closure 10 is mounted. For example, the axially extending portion 26 is aligned with the sealing ring 19. For example, the leverage line extends around the inner circumference of the cap 11 between the axially extending portion 26 and the sealing ring 19. The interior side of the cap 11 is formed with a protrusion 27 to maintain the cap 11 in engagement with a tool core during production of the package closure 10, which will be describe below. For example, the leverage line coincides with said protrusion 27. For example, the protrusion 27 extends around the circumference between the axially extending portion 26 and the sealing ring 19.

The pull-ring 15 is connected to the top portion 13 of the cap 11 through a hinge 28, which is illustrated more clearly in FIG. 3c. In the illustrated embodiment, the package closure 10 can be opened by pulling the pull-ring 15 and thereby folding along the hinge 24 and breaking the breakable notch or bridges 23 in the wall 14. Hence, the top portion 13 together with the axially extending portion 26, the sealing ring 29, the axially extending portion 25 and the upper portion of the wall 14 form an openable lid, which can be closed again for closing and sealing the package closure 10 after it has been opened. The hinge 28 of the pull-ring 26 is, e.g. arranged opposite the hinge 24 in the wall 14. For example, the pull-ring 15 is a closed loop. For example, the cap 11 forms a lid functioning without threads, which sometimes is called a flip lid. For example, the breakable bridges 23 form a tamper-proof function, wherein first-time opening or unauthorised opening of the package closure 10 can be detected. In the illustrated embodiment, the cap is formed with a resiliently flexible locking tab 29 having a radially inward extending protrusion 30 for releasable locking cooperation with the flange 18, a recess or similar of the neck 12.

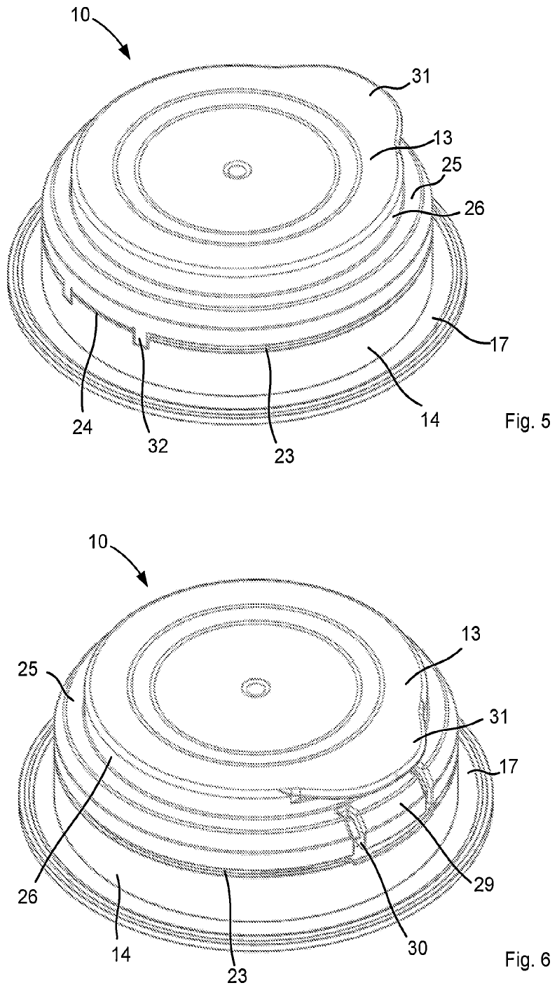

With reference to FIGS. 4-6 the package closure 10 is illustrated according to a second embodiment of the present invention, wherein the pull-tab 15 is replaced by a gripping extension 31 for opening of the cap 11. The gripping extension 31 extends from the top portion 13 and at least partially radially outward beyond the axially extending portion 26. The axially extending portion 26 connects the top portion 13 to the sealing ring 19 and also connects the top portion 13 to the wall 14 through the radially extending portion 25. For example, the gripping extension 31 is arranged opposite the hinge 24 and, e.g. axially above the locking tab 29.

The package closure according to the second embodiment is formed with one or more resiliently flexible holding tabs 32 for holding the cap 11 in the open position. The holding tabs 32 are arranged adjacent the hinge 24 or hinges, if more than one hinge is used. The holding tabs 32 extend along the wall 14 when the cap 11 is closed and extend radially inward when the cap 11 is open. The holding tabs 32 are fixed to the upper part of the cap 11, such as the upper portion of the wall 14, and are movable therewith when the upper part of the cap 11 is moved around the hinge 24. The holding tabs 32 cooperate with a rib 33 of the neck 12 to hold the cap 11 in the open position. The rib 33 extends radially outward from the tubular portion 16, which can be seen in FIG. 4. When the cap 11 is opened, a free end of the holding tabs 32 pass the rib 33 and are held in position by the inherent resilient flexible properties of the holding tabs 32 until force is applied to close the cap 11.

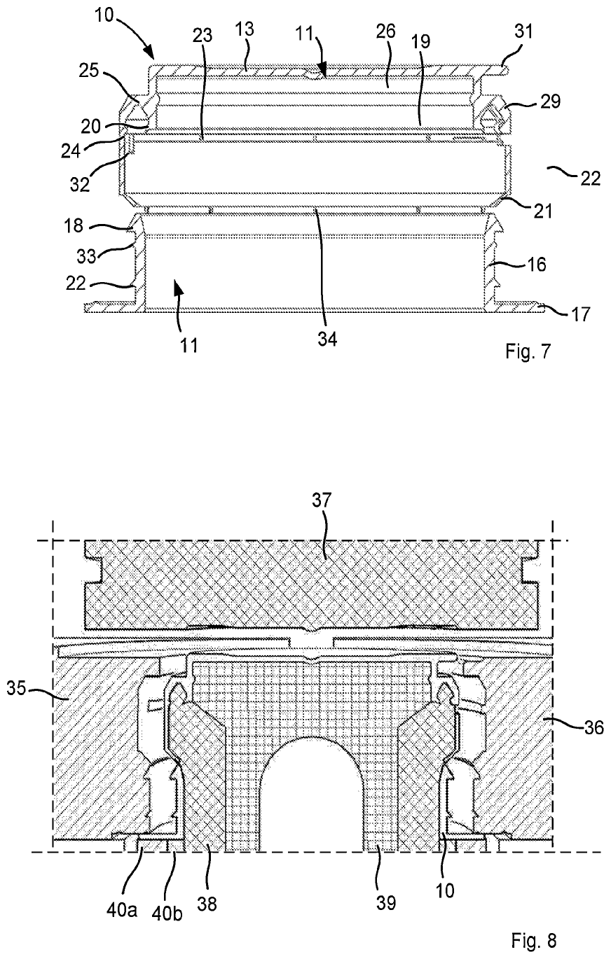

With reference to FIG. 7, a moulded and semi-finished package closure 10 according to the second embodiment is illustrated schematically, wherein the package closure 10 has been moulded in a single integrated piece but not yet folded and pushed together so that the wall 14 of the cap 11 encloses the tubular portion 16 of the neck 12. As can be seen in FIG. 7 the neck 12 is connected to the cap 11 through breakable bridges 34. Alternatively a breakable notch can be used. The breakable bridges 34 connect a foldable portion 21 of the cap and the end of the tubular portion 16 of the neck 12. The foldable portion 21 is to be folded and thus form the folded portion 21, so the same reference number is used for both the foldable portion and the folded portion.

In FIGS. 8-12 production of the package closure 10 by means of a device for producing it is illustrated schematically. The device for producing the package closure 10 comprises a movable first jaw 35, a movable second jaw 36, a counterpart 37 and a tool core having an outer first tool core part 38 and an inner second tool core part 39 interacting with the jaws and the counterpart to form a mould for receiving an amount of plastic material for forming the package closure 10 with the neck 12 and the cap 11 as illustrated schematically in FIG. 7. Optionally, the counterpart is movable, e.g. in the axial direction. Alternatively, the counterpart 37 is connected to one of the jaws or is arranged in two parts, wherein one part is connected to the first jaw and the other part is connected to the second jaw. The device further comprises a movable ejector 40 comprising an outer ejector 40a and an inner ejector 40b, which are axially displaceable in relation to each other, for forming and ejecting the produced package closure 10. The device is arranged as a moulding tool for moulding plastic materials. For example, the device or parts thereof can be heated and cooled in a conventional manner.

The outer first tool core part 38 is arranged for forming the interior side of the tubular portion 16 of the neck 12. The outer first tool core part 38 is also arranged for forming one side of a foldable portion (to be the folded portion) 21 and the interior side of the wall 14 of the cap 11. Hence, the outer first tool core part 38 is arranged for forming the wall 14 with greater inner diameter than the inner diameter of the tubular portion 16 of the neck 12. The outer first tool core part 38 is arranged for forming the foldable portion 21 between the wall 14 and the tubular portion 16 and e.g. with an inclined angle outward and upward from the neck 12. Hence, the outer first tool core part 38 is arranged for forming the foldable portion 21 with an inclined angle inward and downward from the wall 14. The outer first tool core part 38 and/or at least one of the jaws 35, 36 is/are arranged for forming the breakable bridges 23 and the hinge 24 in the wall 14. The outer first tool core part 38 and/or at least one of the jaws 35, 36 is/are arranged for forming the breakable bridges 34 between the cap 11 and the neck 12. In the illustrated embodiment, the outer first tool core part 38 is also arranged for forming an outer side of the sealing ring 19 and the sealing flange 20. The outer first tool core part 38 and at least one of the jaws 35, 36 are arranged for forming the locking tab 29. The second inner tool core part 39 is arranged for forming the interior side of the top portion 13, the interior side of the axially extending portion 26 and an interior side of the sealing ring 19. The inner second toll core part 39 is arranged for forming the protrusion 27 for holding the cap 11 during folding of the foldable portion 21. The attachment portion 17 is formed by the jaws 35, 36 and the inner and outer ejectors 40a, 40b. For example, the jaws 35, 36 are movable in the radial direction.

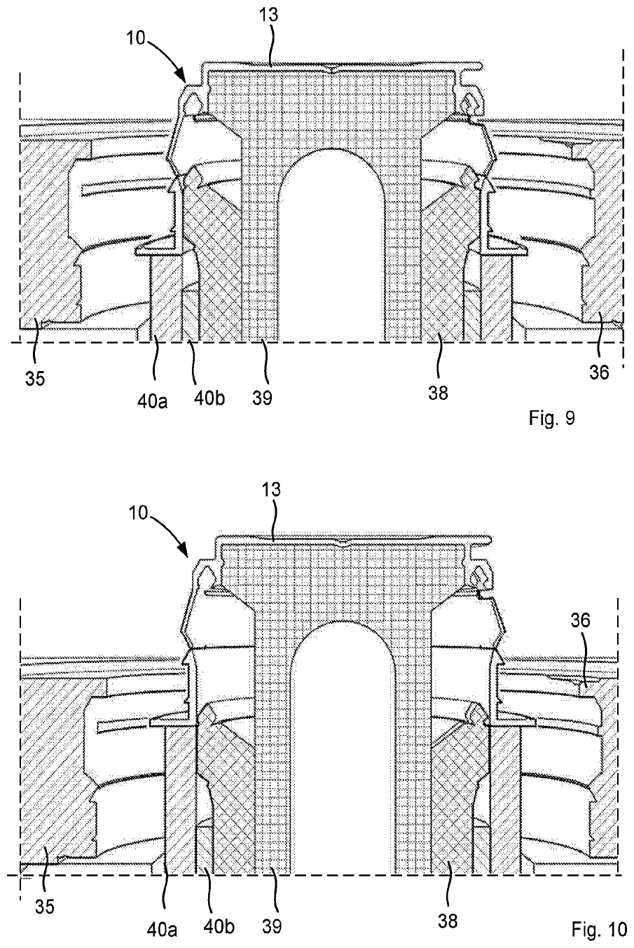

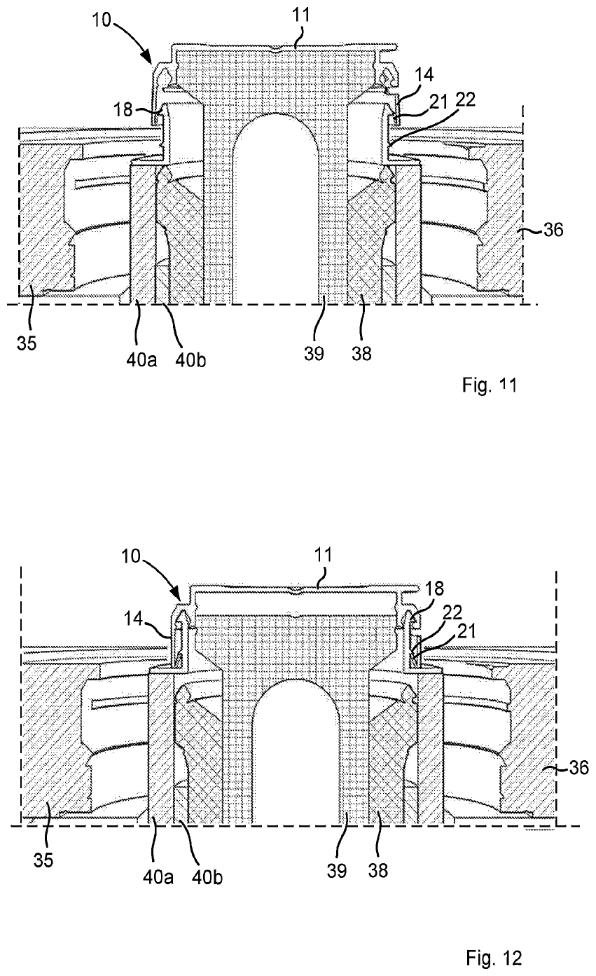

With reference to FIG. 9, the outer first tool core part 38, the second tool core part 39 and the inner and outer ejectors 40a, 40b are axially displaceable in relation to each other. Hence, the outer first tool core part 38 is movable in relation to the inner second tool core part 39. The end part of the outer first tool core part 38 for forming the interior of the wall 14 is forced to pass the more narrow tubular portion 16, wherein the tubular portion 16 temporarily is expanded. When the outer first tool core part 38 has passed the more narrow tubular portion 16 it regains its original shape due to the inherent resilient flexible properties of the material and the material e.g. still being soft and warm from the moulding process. When the outer first tool core part 38 and the inner second tool core part 39 are displaced in relation to each other, the latter is engaging the protrusion 27. The outer ejector 40a is displaced in relation to the inner ejector 40b to allow axial relative movement between the cap 11 and the neck 12 as illustrated in FIGS. 9 and 10. For example, the inner second tool core part 39 and the outer ejector 40a are displaced axially in a first direction in relation to the outer first tool core part 38 and the inner ejector 40b to push the tubular portion 16 of the neck 12 passed the outer first tool core part 38. The outer first tool core part 38 is disengaged from the package closure 10, wherein the tubular portion 16 returns to its original shape as illustrated in FIG. 11. After releasing the package closure 10 from the outer first tool core part 38, the inner second tool core part 39 is displaced axially in an opposite second direction in relation to the outer ejector 40a while bringing the cap 11 along therewith due to the protrusion 27, so that the breakable bridges 34 between the neck 12 and the cap 11 are broken and the foldable portion 21 is folded and brought to engage the locking protrusion 22 as illustrated in FIG. 12, wherein the package closure 10 is ejected from the device by means of the outer ejector 40a. Alternatively, the outer ejector 40a is displaced axially in relation to the inner second tool core part 39 (and also in relation to the outer first tool core part 38 and the inner ejector 40b) in the first direction to push the tubular portion 16 neck into the cap and eject the package closure.

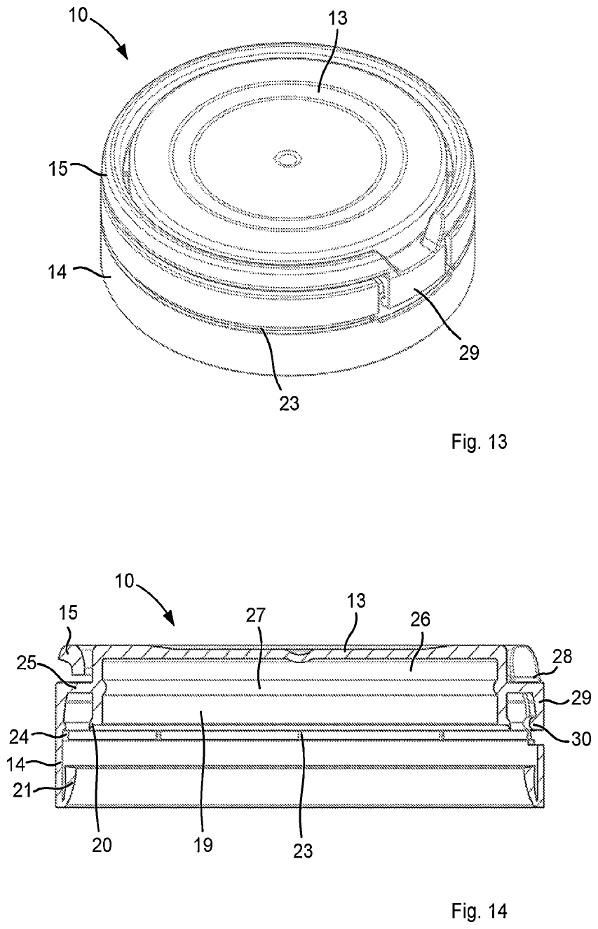

With reference to FIGS. 13 and 14 a package closure 10 is illustrated according to a third embodiment, which is similar to the first embodiment but without the neck 12. Hence, the package closure 10 according to the third embodiment is arranged to be mounted on a package, such as the neck 12 of a bottle or similar. The package closure according to the third embodiment comprises the cap 11 with the top portion 13, the wall 14, the pull-ring 15, the sealing ring 19 with the sealing flange 20, the folded portion 21, the optional breakable bridges 23, the hinge 24, the radially extending portion 25, the axially extending portion 26, the protrusion 27, the hinge 28 for the pull-ring and the optional locking tab 29 with the protrusion 30.

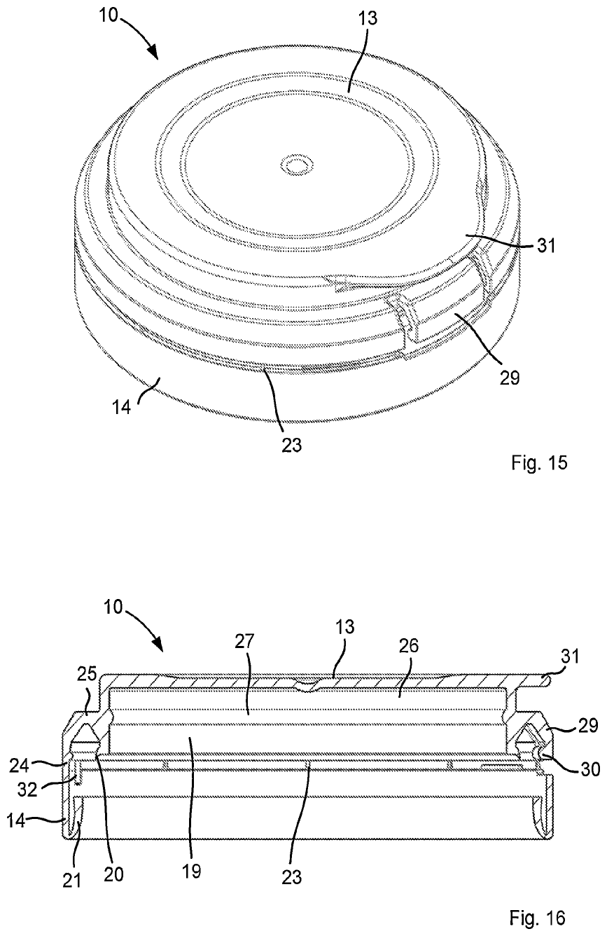

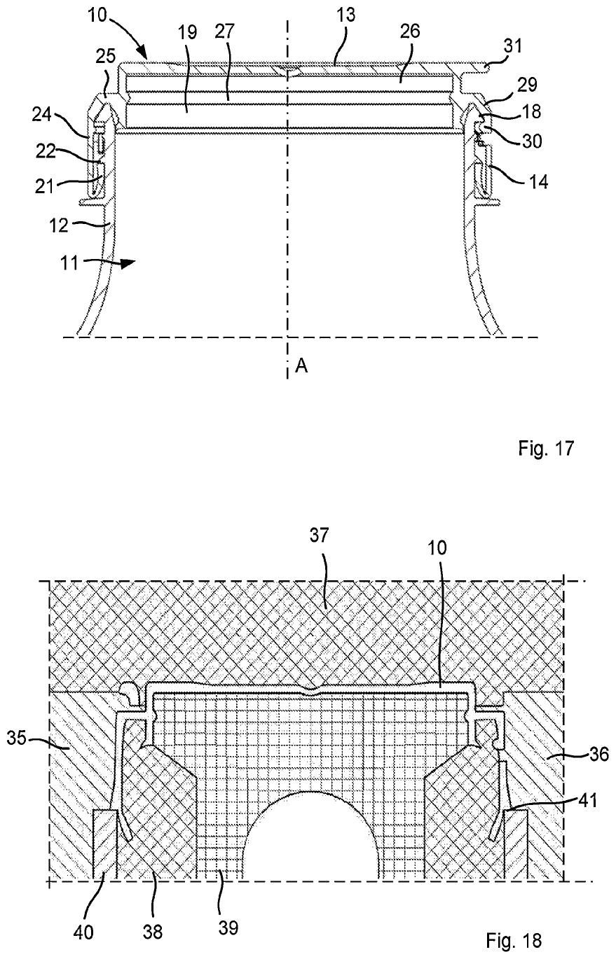

With reference to FIGS. 15 and 16 a package closure 10 is illustrated according to a fourth embodiment, which is similar to the second embodiment but without the neck 12. Hence, the package closure 10 according to the fourth embodiment comprises the cap 11 with the top portion 13, the wall 14, the gripping extension 31, the sealing ring 19 with the sealing flange 20, the folded portion 21, the optional breakable bridges 23, the hinge 24, the radially extending portion 25, the axially extending portion 26, the protrusion 27, the optional locking tab 29 with the protrusion 30 and the optional holding tabs 32. The package closure according to the fourth embodiment is arranged to be mounted on a package, such as the neck 12 of a bottle, which is illustrated in FIG. 17. Similar applies for the third embodiment with the pull-ring 15 instead of the gripping extension 31. Hence, the neck 12 of the bottle is arranged with the tubular portion 16, the flange 18 and the locking protrusion 22 for cooperation with the folded portion 21 as described above. The sealing flange 20 of the sealing ring 19 engages the interior side of the tubular portion 16 of the neck 12. The protrusion 30 of the locking tab 29 cooperates for example with the flange 18 of the neck 12. According to the third and fourth embodiments the folded portion 21 is connected to an end of the wall 14 opposite the top portion 13 and is folded inward and upward to form a locking function together with the protrusion 18 on the exterior side of the neck 12. The folded portion 21 is resiliently flexible by the inherent properties of the material and can be pushed over and beyond the protrusion 18 and then spring back to form the locking function. Hence, the package closure 10 cannot be unintentionally removed from the package after being mounted thereon.

In FIGS. 18-22 production of the package closure 10 similar to the third embodiment is illustrated schematically. The device for producing the package closure 10 comprises the movable first jaw 35, the movable second jaw 36, the counterpart 37 and the tool core having the outer first tool core part 38 and the inner second tool core part 39 interacting with the jaws and the counterpart to form a mould for receiving an amount of plastic material for forming the package closure 10 as illustrated schematically in FIG. 18. The device further comprises the movable ejector 40 for forming and ejecting the produced package closure 10 but as a one-part ejector instead of the two-part ejector described above. The device is arranged as a moulding tool for moulding plastic materials. For example, the device or parts thereof can be heated and cooled in a conventional manner. The device is similar to the device described above with the difference that no neck is moulded and that the ejector 40 forms and pushes an edge portion 41 between the wall 14 and the foldable portion 21.

The outer first tool core part 38 is arranged for forming the interior side of the wall 14. The outer first tool core part 38 is also arranged for forming at least one side of the foldable portion (to be the folded portion) 21 and optionally both sides thereof. For example, the outer first tool core part 38 is arranged for forming the foldable portion 21 with an inclined angle inward and downward from the wall 14. The outer first tool core part 38 and/or at least one of the jaws 35, 36 is/are arranged for forming the breakable bridges 23 and the hinge 24 in the wall 14. In the illustrated embodiment, the outer first tool core part 38 is also arranged for forming an outer side of the sealing ring 19 and the sealing flange 20. The outer first tool core part 38 and at least one of the jaws 35, 36 are arranged for forming the locking tab 29. The second inner tool core part 39 is arranged for forming the interior side of the top portion 13, the interior side of the axially extending portion 26 and an interior side of the sealing ring 19. The inner second toll core part 39 is arranged for forming the protrusion 27 for holding the cap 11 during folding of the foldable portion 21.

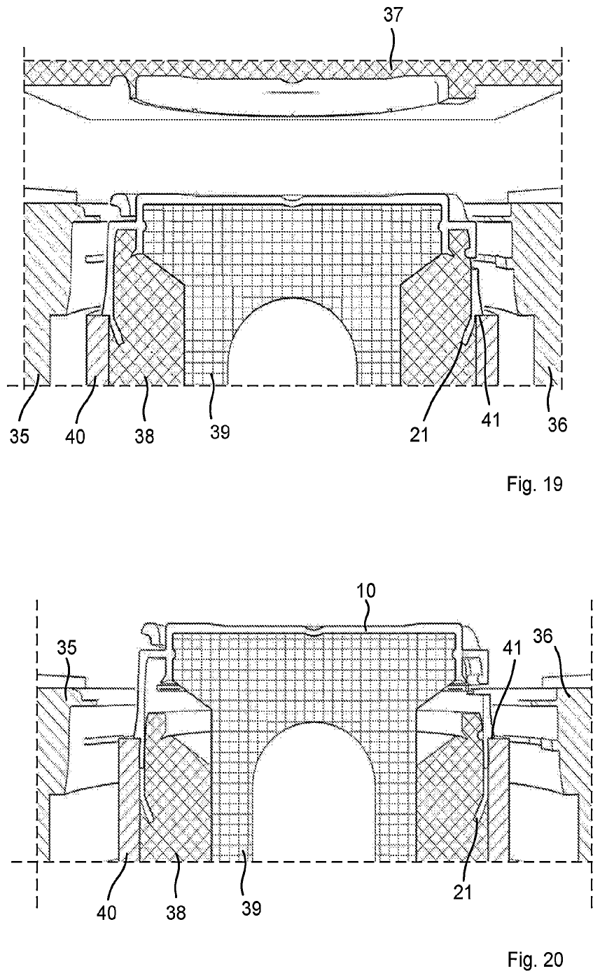

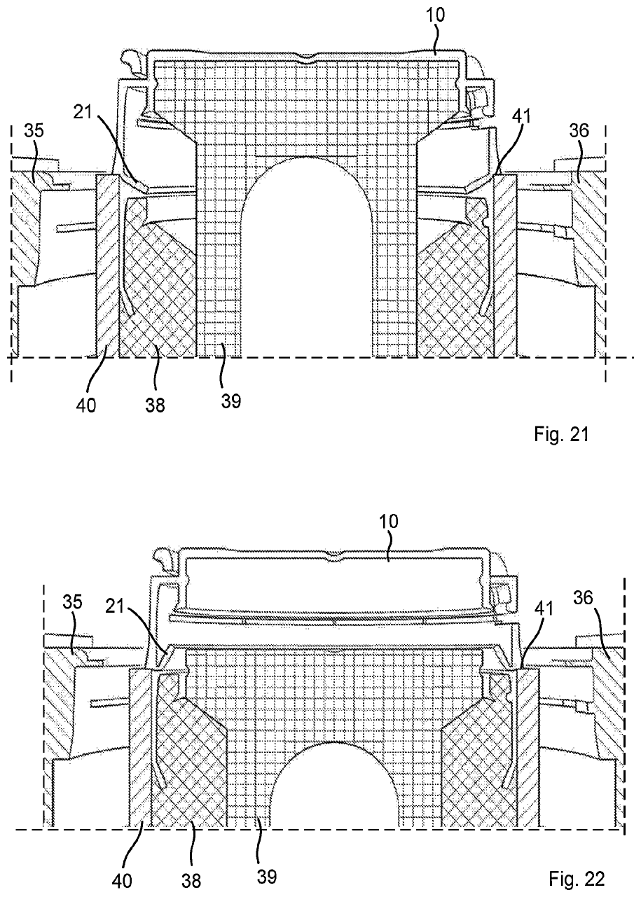

With reference to FIGS. 19 and 20, the outer first tool core part 38 and the second tool core part 39 are axially displaceable in relation to each other. For example, the inner second tool core part 39 is movable in relation to the outer first tool core part 38. The outer first tool core part 38 may be fixed. The package closure 11 is forced to pass the outer first tool core part 38 by means of the inner second tool core part 39 and the ejector being displaced axially in a first direction, wherein the more narrow foldable portion 21 is forced to pass the broader end part of the outer first tool core part 38 for forming the interior of the wall 14, wherein the foldable portion temporarily is folded or expanded. When the foldable portion 21 has passed the outer first tool core part 38 it regains its original shape due to the inherent resilient flexible properties of the material and the material e.g. still being soft and warm from the moulding process, which is illustrated in FIG. 21. After the foldable portion 21 has been disengaged from the outer first tool core part 38, the inner second tool core part 39 and the ejector 40 are displaced in the opposite second axial direction, wherein the inner second tool core part 39 due to engaging the protrusion 27 brings the top portion 13 with it and wherein the foldable portion 21 is folded by engaging the outer first tool core part 38, which is illustrated in FIG. 21. Then, the package closure with the folded portion 21 is ejected from the device by means of the relative axial movement between the ejector 40 and the inner second tool core part 39 releasing the protrusion 27 from the inner second tool core part 39 by the inherent resilient flexible properties of the package closure 10, which is illustrated in FIG. 22. Hence, the inner second tool core part 39 and the ejector 40 are first displaced axially in the first direction in relation to the outer first tool core part 38 to bring the folded portion 21 to pass the outer first tool core part 38. When the foldable portion 21 is disengaged from outer first tool core part 38 it springs back. Then, the inner second tool core part 39 together with the ejector 40 is displaced axially in the opposite second axial direction in relation to the outer first tool core part 38 while the inner second tool core part 39 brings the cap 11 along therewith due to the protrusion 27, so that the foldable portion 21 is folded to its folded position by contacting the outer first tool core part before being ejected from the device by means of the ejector 40.

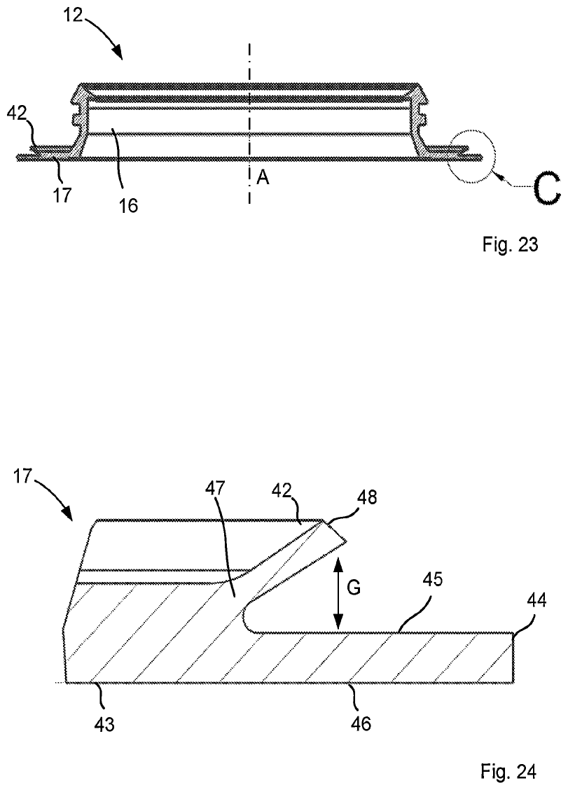

With reference to FIGS. 23 and 24 the attachment portion 17 of the neck 12 is illustrated according to one embodiment. The attachment portion 17 is arranged for attachment to the package, such as by melting or welding the attachment portion 17 or a part thereof to the package. For example, the attachment portion 17 is arranged for attachment to a package wall through ultrasonic welding. The attachment portion 17 extends radially outward from the tubular portion 16, such as perpendicular from the tubular portion 16 or at a slanted angle outward and either downward or upward from the tubular portion 16. For example, the attachment portion 17 connects to one end of the tubular portion 16, i.e. the lower end which is opposite the top portion 13 of the cap 11. For example, the attachment portion 17 extends continuously around the tubular portion 16. For example, the jaws 35, 36 are arranged to form the welding protrusion 42.

The attachment portion 17 comprises a welding protrusion 42. The welding protrusion 42 is arranged to facilitate attachment of the neck 12 to the package, such as by welding, e.g. ultrasonic welding. For example, the welding protrusion 42 is arranged to engage the package and melt to and/or together with the material of the package. It is believed that the welding protrusion 42, which will be described in more detail below, directs melting of the material away from the tubular portion 16 and, if applicable, the cap 11.

FIG. 23 illustrates the neck 12 and FIG. 24 is an enlarged portion indicated with C in FIG. 23. FIG. 24 illustrates a portion of the neck 12 with the welding protrusion 42. As can be seen in FIG. 24 the attachment portion 17 comprises a base portion 43 and the welding protrusion 42. The base portion 43 comprises a first end, a second end 44, a first surface 45 and a second surface 46 opposite the first surface 45. For example, the first end of the base portion 43 is attached to the tubular portion 16, wherein the second end 44 of the base portion 43 is a free end. The first and second surfaces 45, 46 of the base portion 43 extend between the first and second ends thereof. For example, the first surface 45 is an upper surface and the second surface 46 is a lower surface. For example, the second surface 46 is substantially flat.

The welding protrusion 42 has a first end 47 and a second end 48 and extends from the first surface of the base portion 43. Alternatively, the welding protrusion 42 extends from the second surface of the base portion 43. The first end 47 of the welding protrusion 42 is connected to the base portion 43 and the second end 48 is a free end. The welding protrusion 42 extends from the base portion 43 forming a gap between a portion of the welding protrusion 42 and the base portion 43. The second end 48 of the protrusion 42 is arranged with an axially extending gap G to the first surface 45 of the base portion 43. For example, the gap G is increasing from the first end 47 to the second end 48 of the welding protrusion 42. The welding protrusion 42 extends, e.g., from the first surface of the base portion 43 in an angle, so that the welding protrusion 42 is inclined away from the first surface 45 of the base portion 43. For example, the welding protrusion 42 extends upward and radially outward in an angle of maximum 70 degrees or maximum 60 degrees, such as maximum 45 degrees. Alternatively, the welding protrusion 42 extends radially with a gap, such as a gap with continuous height, to the underlying part of the base portion 43. For example, the base portion 43 is thinner on a distal, peripheral side of the welding protrusion 42 and thicker on a proximal, central side of the welding protrusion 42. For example, the base portion 43 extends continuously around the tubular portion 16, and the welding protrusion 42 is, e.g. arranged continuously on the base portion 43 around the tubular portion 16.

The welding protrusion 42 is resiliently flexible. Hence, the welding protrusion 42 is movable around its first end 47, so that the second end 48 is movable down or up and down due to its inherent flexible properties. Due to its inherent flexible properties, the welding protrusion 42 is biased to a default position and it requires a force to displace it from said position. This is believed to also improve the welding properties by ultrasonic welding.

For example, the welding protrusion 42 connects to the base portion 43, so that the gap between the welding protrusion 42 and the base portion 43 is wedge-shaped. For example, the welding protrusion 42 connects to the base portion 18 in a sharp angle, wherein the gap is pointed. Alternatively, as illustrated in FIG. 24, the welding protrusion 42 connects to the base portion 43 through a curve. This is believed to improve the stiffness of the welding protrusion 42, so that it requires a larger force to displace it from its default position, which in turn is believed to improve the ultrasonic welding of the attachment portion 17 to a package wall.

1. A method of producing a package closure of plastic material by means of a mold comprising movable jaws, a counterpart, an outer first tool core part, an inner second tool core part and an ejector, wherein the package closure has an axis, and wherein the outer first tool core part, the inner second tool core part and the ejector are axially displaceable relative each other, comprising the steps of
a) by means of the movable jaws and the counterpart forming an exterior of a cap of the package closure, and by means of the outer first tool core part and the inner second tool core part forming an interior of the cap, wherein an interior of an axially extending wall of the cap, at least an interior of a foldable portion of the cap and a radially outward facing side of a sealing ring of the cap is formed by the outer first tool core part, wherein the interior of a top portion of the cap and a radially inward facing side of the sealing ring is formed by the inner second tool core part, and wherein a hinge is formed in the cap by the movable jaws and the outer tool core part for opening of the cap,
b) removing the jaws from the formed package closure,
c) axially displacing at least one of the outer first tool core part and the second tool core part in relation to the other in a first direction, thereby disengaging the cap from the outer first tool core part while keeping the inner second tool core part engaged with the cap,
d) axially displacing the inner second tool core part, the outer first tool core part and/or the ejector in relation to at least one of the others in the first direction or in an opposite second direction while folding the foldable portion inward to its folded position through an inherent flexibility of the package closure,
e) displacing the package closure in relation to the second tool core part by the ejector to disengage the package closure from the second tool core part.

2. The method of claim 1, comprising the step of, in step a), forming the wall with an upper portion and a lower portion connected through the hinge and a breakable notch or breakable bridges in the wall by means of the jaws and the outer first tool core part.

3. The method of claim 1, comprising the step of folding the foldable portion inward and upward.

4. The method of claim 1, comprising the step of forming a sealing flange on the sealing ring by means of the outer first tool core part.

5. The method of claim 1, comprising the steps of forming a flexible protrusion on the interior side of the sealing ring by means of the inner second tool core part in step a) and by means of said protrusion keeping the second tool core part engaged with the cap in step d).

6. The method of claim 1, comprising, in step a), forming the cap and a neck of the package closure as a single integrated piece, wherein the foldable portion is connected to the neck through one or more breakable bridges, and in step d) continue to displace the inner second tool core part and the outer first tool core part and/or the ejector in relation to each other to break the breakable bridges and separate the neck and the cap into two pieces, wherein a tubular portion of the neck is enclosed by the wall of the cap.

7. The method of claim 6, comprising, in step a), forming a locking protrusion on the exterior of the neck by means of the jaws.

8. The method of claim 7, comprising, in step d), bringing the folded portion to pass and engage the locking protrusion.

9. The method of claim 1, comprising, in step a), forming, in a portion of the wall, by means of one or more of the jaws and the outer first tool core part, a flexible locking tab having a radially inward extending protrusion for releasable locking cooperation with a flange or recess of the neck.

10. The method of claim 1, comprising, in step a), forming the cap with an axially extending portion connecting the radially extending top portion and the sealing ring, wherein the wall is connected to an end of the axially extending portion opposite the top portion and an end of the sealing ring opposite a free end thereof through a radially extending portion.

11. The method of claim 1, comprising, in step c), displacing an outer first ejector and an inner second ejector axially in relation to each other.

12. The method of claim 1, comprising the steps of forming one or more flexible holding tabs adjacent the hinge, so that the holding tabs, in the open position of the cap, extend radially inward for cooperation with a rib of the neck to hold the cap in the open position.

13. A device for producing a package closure of plastic material, said package closure having an axis, wherein the device comprises a mold for molding plastic materials, said mold comprising a radially movable first jaw a radially movable second jaw, a counterpart, an outer first tool core part, an inner second tool core part and an ejector, wherein the outer first tool core part, the second tool core part and the ejector are axially displaceable relative each other, wherein
the movable jaws and the counterpart are arranged to form an exterior of a cap of the package closure,
the outer first tool core part is arranged to form an interior of an axially extending wall of the cap and a radially outward facing side of a sealing ring of the cap,
the inner second tool core part is arranged to form the interior of a top portion of the cap and a radially inward facing side of the sealing ring,
the movable jaws and the outer tool core part are arranged to form a hinge in the cap,
wherein at least one of the outer first tool core part and the inner second tool core part is axially displaceable in relation to the other in a first direction for disengaging the cap from the outer first tool core part while keeping the second tool core part engaged with the cap, wherein
the outer first tool core part is arranged for forming at least an interior of a foldable portion of the cap,
at least one of the inner second tool core part, the outer first tool core part and the ejector is axially displaceable in relation to at least one of the others further in the first direction or in a second direction opposite to the first direction to fold the foldable portion inward to its folded position through an inherent flexibility of the package closure.

14. The device of claim 13, wherein the jaws and the outer first tool core part are arranged to form the wall with an upper portion and a lower portion connected through the hinge and a breakable notch or breakable bridges.

15. The device of claim 13, wherein the device comprises an outer first ejector and an inner second ejector for forming a radially extending attachment portion of a neck of the package closure together with the jaws, and wherein the first and second ejectors are axially displaceable in relation to each other.

16. The device of claim 13, wherein the device is arranged for forming the cap and a neck of the package closure as a single integrated piece, wherein the foldable portion is connected to the neck through one or more breakable bridges being breakable during displacement of the inner second tool core part and the outer first tool core part and/or the ejector in relation to each other.

17. The device of claim 16, wherein the jaws comprise a radially extending recess for forming a locking protrusion on the exterior of the neck.

18. The device of claim 13, wherein the outer first tool core part comprises a radially inward extending recess for forming, in a portion of the wall, a flexible locking tab having a radially inward extending protrusion for releasable locking cooperation with a flange or recess of the neck.

19. The device of claim 13, wherein the jaws and the outer first tool core part are arranged to form one or more flexible holding tabs adjacent the hinge, so that the holding tabs, in the open position of the cap, extend radially inward for cooperation with a rib of the neck to hold the cap in the open position.

20. A package closure comprising a cap for closing an opening of a neck, wherein the cap has a centre axis and is formed with a radially extending top portion, an axially extending sealing ring and an axially extending wall enclosing the sealing ring, wherein
one end of the wall is formed with a folded portion extending radially inward and upward to a free end thereof, and
the cap is formed with a hinge, wherein the cap is openable by folding along the hinge.

21. The package closure of claim 20, wherein the wall is formed with an upper wall portion and a lower wall portion connected through the hinge and a breakable notch or breakable bridges, wherein the cap is openable by tearing the breakable notch or breakable bridges and folding along the hinge.

22. The package closure of claim 20, wherein the wall is formed with a flexible locking tab having a radially inward extending protrusion for releasable locking cooperation with a flange or recess of the neck.

23. The package closure of claim 20, wherein cap is formed with one or more flexible holding tabs adjacent the hinge, so that the holding tabs, in the open position of the cap, extend radially inward for cooperation with a rib of the neck to hold the cap in the open position.

24. The package closure of claim 20, wherein the cap comprises an axially extending portion connecting the radially extending top portion and the sealing ring, wherein the wall is connected to an end of the axially extending portion opposite the top portion and an end of the sealing ring opposite a free end thereof through a radially extending portion.

25. The package closure of claim 20, wherein the sealing ring comprises a radially outward extending sealing flange.
